(19) United States
(12) Patent Application Publication
(10) Pub. No.: US 2017/0197491 A1
(43) Pub. Date: Jul. 13, 2017

(54) AIR CONDITIONING CONTROL DEVICE

(71) Applicant: KABUSHIKI KAISHA TOKAI RIKA DENKI SEISAKUSHO, Aichi (JP)

(72) Inventor: Ryoko NAKANO, Aichi (JP)

(21) Appl. No.: 15/332,722

(22) Filed: Oct. 24, 2016

(30) Foreign Application Priority Data
Jan. 7, 2016 (JP) 2016-001734

(51) Int. Cl. B60H 1/00; G06F 3/0484; G06F 3/0488; G06F 3/041; G06F 3/044

(52) U.S. Cl. CPC B60H 1/00985; B60H 1/00878; B60H 1/00828; G06F 3/0416; G06F 3/044; G06F 3/04883; G06F 3/04847

(57) ABSTRACT

An air conditioning control device includes an operation detector that detects a touch operation made in an operation area by a detection target, and a controller that sets, in the operation area, a two-dimensional coordinate system having a first axis related to a first setting value and a second axis related to a second setting value, and outputs a control signal to control an air conditioning device in accordance with the first setting value and the second setting value based on coordinates of the detection target in the two-dimensional coordinate system, the coordinates being detected by the operation detector.

The present application is based on Japanese patent application No.2016-001734 filed on Jan. 7, 2016, the entire contents of which are incorporated herein by reference.

### TECHNICAL FIELD

The present invention relates to an air conditioning control device.

### BACKGROUND ART

An operation device, including a knob operation part operated by an operator pinching the part with his or her fingertip, a first movement amount detection means that detects a rotation amount of the knob operation part, a second movement amount detection means that detects a tilt amount of the knob operation part, and a control means that sets a temperature on the basis of a detection output from the first movement amount detection means and sets an airflow rate on the basis of a detection output from the second movement amount detection means, is known as an example of conventional technology (see Patent Document 1, for example).

With this operation device, the temperature, airflow rate, and the like can be set quickly through the knob operation part.

### CITATION LIST

### Patent Literature

Patent Document 1: Japanese Unexamined Patent Application Publication No. 2009-214570A

### SUMMARY OF INVENTION

### Technical Problem

However, with the conventional operation device, it is necessary to rotate the knob operation part while tilting that part, tilt the knob operation part while rotating that part, or the like in order to set the temperature and the airflow rate simultaneously.

Accordingly, an object of the present invention is to provide an air conditioning control device with improved operability.

### Solution to Problem

One aspect of the present invention provides an air conditioning control device including: an operation detector that detects a touch operation made in an operation area by a detection target; and a controller that sets, in the operation area, a two-dimensional coordinate system having a first axis related to a first setting value and a second axis related to a second setting value, and outputs a control signal to control an air conditioning device in accordance with the first setting value and the second setting value based on coordinates of the detection target in the two-dimensional coordinate system, the coordinates being detected by the operation detector.

### Advantageous Effects of Invention

According to the present invention, the operability can be improved.

### BRIEF DESCRIPTION OF DRAWINGS

FIG. 1A is a schematic diagram illustrating an example of the arrangement of an air conditioning control device according to an embodiment.

FIG. 1B illustrates an example of a block diagram of the air conditioning control device.

FIG. 1C is a schematic diagram illustrating an example of an operation area of the air conditioning control device.

FIG. 2A is a schematic diagram illustrating an example of a case where a touch operation has been made in the operation area of the air conditioning control device according to the embodiment.

FIG. 2B is a schematic diagram illustrating an example of a display after the touch operation has been made.

FIG. 2C is a schematic diagram illustrating an example of a case where a tracing operation has been made in the operation area.

FIG. 2D is a schematic diagram illustrating an example of a display after the tracing operation has been made.

FIG. 3 is a flowchart illustrating an example of operations performed by the air conditioning control device according to the embodiment.

### DESCRIPTION OF EMBODIMENT

### Overview of Embodiment

An air conditioning control device according to an embodiment primarily includes an operation detector that detects a touch operation made in an operation area by a detection target, and a controller that sets, in the operation area, a two-dimensional coordinate system having a first axis related to a first setting value and a second axis related to a second setting value, and outputs a control signal to control an air conditioning device in accordance with the first setting value and the second setting value based on coordinates of the detection target in the two-dimensional coordinate system, the coordinates being detected by the operation detector.

The air conditioning control device can set the first setting value and the second setting value on the basis of the coordinates at which the operation has been detected, thereby enabling the operability to be improved as compared to a case where the first setting value and the second setting value are set separately.

### EMBODIMENT

### Overview of Air Conditioning Control Device 1

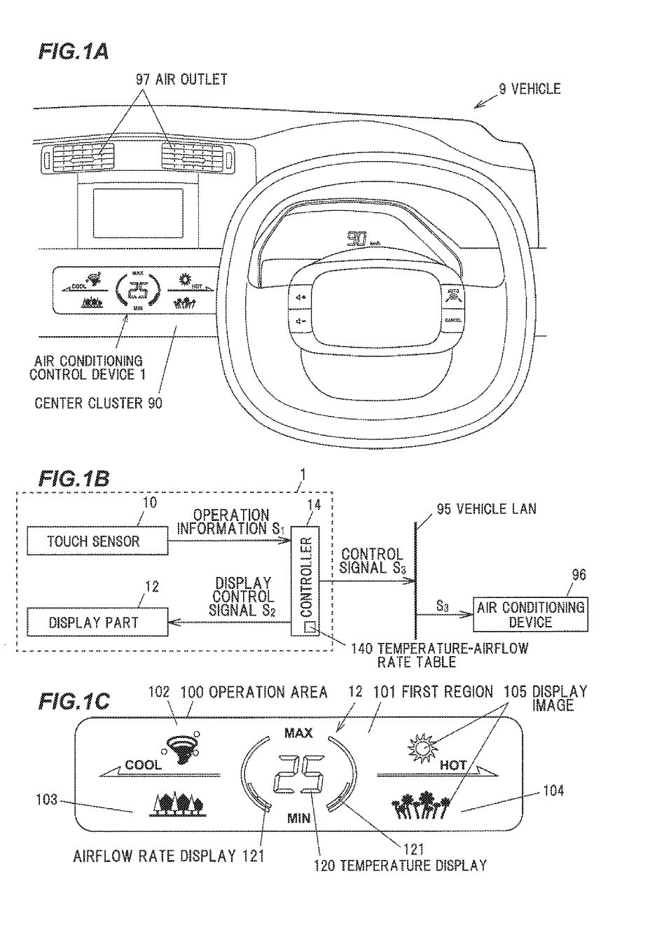

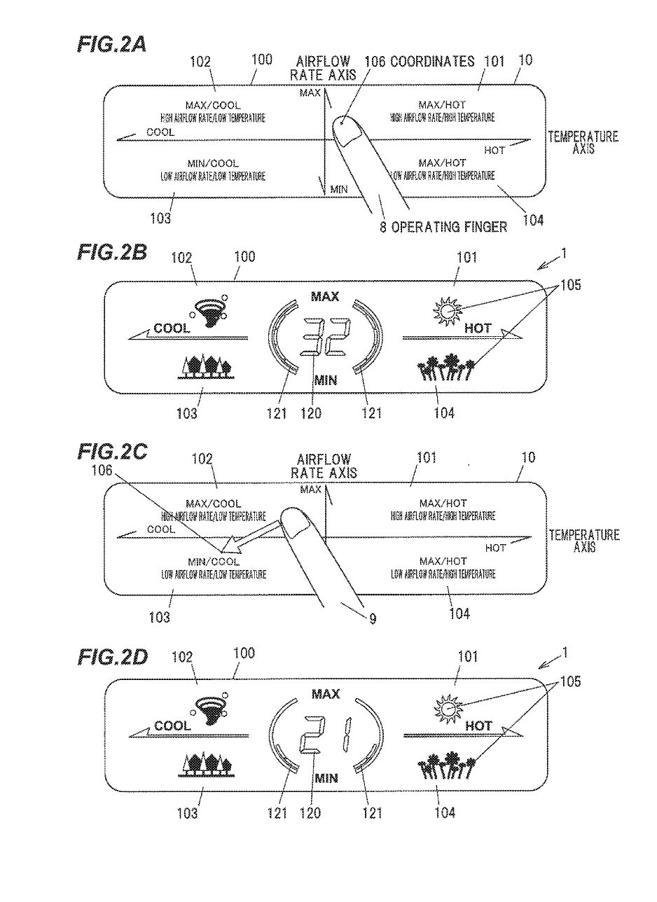

FIG. 1A is a schematic diagram illustrating an example of the arrangement of an air conditioning control device according to the embodiment, FIG. 1B illustrates an example of a block diagram of the air conditioning control device, and FIG. 1C is a schematic diagram illustrating an example of an operation area of the air conditioning control device. FIG. 2A is a schematic diagram illustrating an example of a case where a touch operation has been made in the operation area of the air conditioning control device according to the embodiment, FIG. 2B is a schematic diagram illustrating an example of a display after the touch operation has been made, FIG. 2C is a schematic diagram illustrating an example of a case where a tracing operation has been made in the operation area, and FIG. 2D is a schematic diagram illustrating an example of a display after the tracing operation has been made. In the drawings associated with the following embodiment, ratios between elements in the drawings may be different from the actual ratios. In addition, in FIG. 1B, arrows indicate the flows of primary signals, information, and the like.

As illustrated in FIGS. 1A and 1B, an air conditioning control device 1 is arranged in a center cluster 90 of a vehicle 9, and controls a temperature, an airflow rate, and the like of an air conditioning device 96.

This air conditioning control device 1 primarily includes a touch sensor 10 serving as an operation detector that detects a touch operation made in an operation area 100 by a detection target, and a controller 14 that sets, in the operation area 100, a two-dimensional coordinate system having a first axis related to a first setting value and a second axis related to a second setting value, and outputs a control signal S₃ to control the air conditioning device 96 in accordance with the first sefting value and the second setting value based on coordinates of the detection target in the two-dimensional coordinate system, the coordinates being detected by the touch sensor 10.

The first setting value is a temperature of air delivered to the interior of the vehicle 9 by the air conditioning device 96, for example.

The second setting value is an airflow rate of the air delivered to the interior of the vehicle 9 by the air conditioning device 96, for example. As illustrated in FIG. 2A, the first axis is a temperature axis assigned to a horizontal axis, for example. As illustrated in FIG. 2A. the second axis is an airflow rate axis assigned to a vertical axis, for example. The two-dimensional coordinate system is an orthogonal coordinate system in which the temperature axis and the airflow rate axis illustrated in FIG. 2A are orthogonal to each other, for example.

As illustrated in FIG. 1B, the air conditioning control device 1 is electromagnetically connected to a vehicle local area network (LAN) 95, for example.

The air conditioning control device 1 is connected to the air conditioning device 96 via the vehicle LAN 95. The air conditioning device 96 is installed in the vehicle 9, and delivers air, whose temperature and airflow rate has been adjusted under the control of the air conditioning control device 1, to the interior of the vehicle 9 from air outlets 97 and the like.

### Configuration of Touch Sensor 10

The touch sensor 10 detects a touched position on the operation area 100 when the operation area 100 is touched by a part of an operator's body (an operating finger, for example) or with a dedicated pen, for example. The operator can, for example, make a touch operation, a tracing operation, or the like in the operation area 100 to operate the connected air conditioning device 96.

The touch sensor 10 is an electrostatic capacitance-type touch sensor, for example. The touch sensor 10 detects an electrostatic capacitance formed between a detection electrode and the detection target that has approached or made contact with the operation area 100 to determine the coordinates of a detection point, and outputs operation information S₁, which is information on the determined coordinates, to the controller 14. In the present embodiment, the detection target is assumed to be an operating finger to be used by the operator to perform operations.

As illustrated in FIG. 1C, the touch sensor 10 includes, below the operation area 100, a plurality of detection electrodes that intersect with each other while remaining insulated from each other. For example, the detection electrodes arranged in one direction serve as driving electrodes, while the detection electrodes arranged in the other direction serve as readout electrodes. A driving voltage is applied to one selected from the driving electrodes, and while the driving voltage is being applied, the readout electrodes are switched and the electrostatic capacitance is read out. The touch sensor 10 executes this process for all of the detection electrodes for one cycle, and determines coordinates in the operation area 100 on the basis of the read-out electrostatic capacitances.

The touch sensor 10 is also arranged on the entire surface of the operation area 100, or in other words, on a display part 12. Accordingly, the touch sensor 10 is a transparent electrode in which the driving electrodes and the readout electrodes are formed from indium tin oxide (ITO), for example.

Note that as a variation, in a case of not being formed on the display part 12, for example, the touch sensor 10 may be formed of a conductive metal material, such as copper, rather than transparent electrodes.

As illustrated in FIG. 2A, the operation area 100 is primarily divided into a first region 101 to a fourth region 104. The first region 101 to the fourth region 104 correspond, for example, to a first quadrant to a fourth quadrant of the two-dimensional coordinate system, respectively.

The temperature axis is, for example, a coordinate axis having a range of a minimum temperature of 18° C. to a maximum temperature of 32° C. The airflow rate axis is, for example, a coordinate axis having a range of 1 to 5. As such, the temperature axis and the airflow rate axis intersect at a temperature of 25° C. and an airflow rate of 3, for example.

Accordingly, the first region 101 (first quadrant) is a region in which the temperature is higher than 25° C. and lower than or equal to 32° C. and the airflow rate is higher than 3 and lower than or equal to 5, for example. The second region 102 (second quadrant) is a region in which the temperature is higher than or equal to 18° C. and lower than 25° C. and the airflow rate is higher than 3 and lower than or equal to 5. The third region 103 (third quadrant) is a region in which the temperature is higher than or equal to 18° C. and lower than 25° C. and the airflow rate is higher than or equal to 1 and lower than 3. The fourth region 104 (fourth quadrant) is a region in which the temperature is higher than 25° C. and lower than or equal to 32° C. and the airflow rate is higher than or equal to 1 and lower than 3.

Note that in a case where a touch operation and a tracing operation have been made on the temperature axis and the airflow rate axis, the air conditioning control device 1 outputs the control signal S₃ based on the temperature and airflow rate corresponding to the coordinates on the axes, for example.

Display images 105 are formed in the operation area 100. The display images 105 elicits associations with how high or low the temperature is, how high or low the airflow rate is, and the like. The display images 105 are formed in the operation area 100 through printing, for example. The display images 105 are illuminated from a back surface side, for example.

### Configuration of Display Part 12

As illustrated in FIG. 1C, the display part 12 is configured to provide a temperature display 120 and an airflow rate display 121 using liquid crystals, for example. The display part 12 is positioned in the center of the operation area 100, for example.

As illustrated in FIG. 19, the display part 12 is electrically connected to the controller 14, for example.

The display part 12 provides the temperature display 120 and the airflow rate display 121 in accordance with a display control signal S2 output from the controller 14.

The temperature display 120 displays temperatures from 18° C. to 32° C. numerically. The airflow rate display 121 displays the airflow rate range of 1 to 5 by the number of narrow arcs. The number of arcs is 5, for example.

### Configuration of Controller 14

The controller 14 is, for example, a microcomputer including a central processing unit (CPU) that carries out computations, processes, and the like on acquired data in accordance with a stored program, a random access memory (RAM) and a read only memory (ROM) that are semiconductor memories, and the like. A program for operations of the controller 14 and a temperature-airflow rate table 140, for example, are stored in the ROM. The RAM is used as a storage region that temporarily stores computation results and the like, for example.

The temperature-airflow rate table 140 is a table including information on a predetermined temperature and airflow rate combination for each of the first quadrant to the fourth quadrant of the two-dimensional coordinate system, and information on a temperature and airflow rate combination corresponding to coordinates at which the operating finger has been detected.

The controller 14 reads out, from the temperature-airflow rate table 140, a predetermined temperature and airflow rate combination corresponding to the quadrant in which a touch operation has been made, and controls the air conditioning device 96 to deliver air adjusted in accordance with the read-out temperature and airflow rate.

The respective temperature and airflow rate combinations predetermined for the first quadrant to the fourth quadrant are, as illustrated in FIGS. 2A and 2D, high airflow rate/high temperature, high airflow rate/low temperature, low airflow rate/low temperature, and low airflow rate/high temperature. These predetermined temperature and airflow rate combinations are stored in the temperature-airflow rate table 140.

In a case where a touch operation has been made in the first region 101 (first quadrant), the controller 14 outputs, to the air conditioning device 96, the control signal S₃ in accordance with the high airflow rate/high temperature combination, on the basis of the temperature-airflow rate table 140. This high airflow rate/high temperature combination has an airflow rate of 5 and a temperature of 32° C., for example.

In a case where a touch operation has been made in the second region 102 (second quadrant), the controller 14 outputs, to the air conditioning device 96, the control signal S₃ in accordance with the high airflow rate-low temperature combination, on the basis of the temperature-airflow rate table 140. This high airflow rate/low temperature combination has an airflow rate of 5 and a temperature of 18° C., for example.

In a case where a touch operation has been made in the third region 103 (third quadrant), the controller 14 outputs, to the air conditioning device 96, the control signal S₃ in accordance with the low airflow rate/low temperature combination, on the basis of the temperature-airflow rate table 140. This low airflow rate/low temperature combination has an airflow rate of 1 and a temperature of 18° C., for example.

In a case where a touch operation has been made in the fourth region 104 (fourth quadrant), the controller 14 outputs, to the air conditioning device 96, the control signal S₃ in accordance with the low airflow rate/high temperature combination, on the basis of the temperature-airflow rate table 140. This low airflow rate/high temperature combination has an airflow rate of 1 and a temperature of 32° C., for example.

As illustrated in FIG. 2A, in the case where the operator has made a touch operation in the first region 101, detected coordinates 106 are within the first region 101. Accordingly, the controller 14 reads out the airflow rate and temperature combination corresponding to the first region 101 from the temperature-airflow rate table 140, generates the control signal S₃ specifying an airflow rate of 5 and a temperature of 32° C., and outputs the generated signal to the air conditioning device 96. FIG. 2B illustrates a display in the display part 12 after this touch operation has been made.

Additionally, the controller 14 sets the temperature and airflow rate on the basis of the coordinates of an end point of a tracing operation made in the operation area 100.

As illustrated in FIG. 2C, in a case where the operator has traced the operation area 100 with an operating finger 8 to the second region 102, the temperature and airflow rate are determined on the basis of the coordinates 106 of an end point where the operating finger 8 stopped and the temperature-airflow rate table 140. In a case where the coordinates 106 of the end point are coordinates corresponding to (21, 2), for example, the controller 14 generates the control signal S₃ specifying a temperature of 24° C. and an airflow rate of 4, and outputs the generated signal to the air conditioning device 96. FIG. 2D illustrates a display in the display part 12 after this tracing operation has been made.

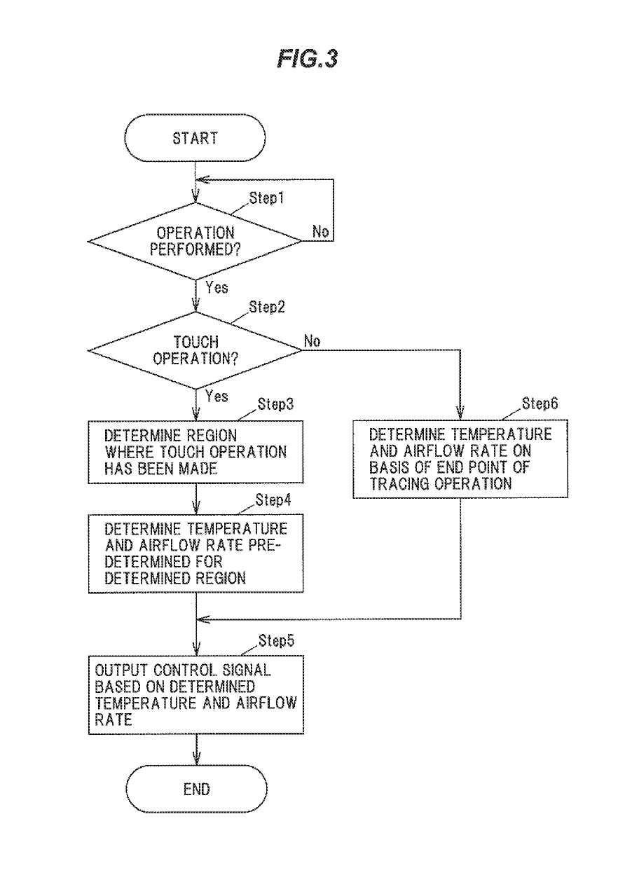

Next, operations of the air conditioning control device 1 according to the present embodiment will be described according to the flowchart in FIG. 3.

### Operations

Upon the power of the vehicle 9 being turned on, the controller 14 of the air conditioning control device 1 periodically obtains the operation information S₁ and determines whether or not an operation has been made. Upon the determination in step 1 being “Yes”, or in other words, upon detection of an operation (Step 1: Yes), the controller 14 checks whether the operation is a touch operation ora tracing operation.

Upon determining that the operation is a touch operation (Step 2: Yes), the controller 14 determines a region (quadrant) in which the touch operation was made (Step 3). This region is one of the first region 101 to the fourth region 104.

Upon determining the region in which the touch operation was made, the controller 14 reads out the predetermined temperature and airflow rate combination corresponding to the determined region (quadrant) from the temperature-airflow rate table 140 and determines the temperature and airflow rate to be notified to the air conditioning device 96 (Step 4). The controller 14 then outputs the control signal S₃ based on the determined temperature and airflow rate to the air conditioning device 96 via the vehicle LAN 95. In addition, the controller 14 generates the display control signal S₂ for displaying the determined temperature and airflow rate, outputs the generated signal to the display part 12 (Step 5), and then terminates the operations based on the touch operation.

In a case where the operation detected in Step 2 is a tracing operation (Step 2: No), the controller 14 reads out the temperature and airflow rate corresponding to the coordinates of the end point of that tracing operation from the temperature-airflow rate table 140 and determines the temperature and airflow rate set by the operator (Step 6).

The controller 14 proceeds to Step 5 and outputs, to the air conditioning device 96 via the vehicle LAN 95, the control signal S₃ based on the determined temperature and airflow rate. In addition, the controller 14 generates the display control signal S₂ for displaying the determined temperature and airflow rate, outputs the generated signal to the display part 12, and then terminates the operations based on the tracing operation.

The air conditioning control device 1 executes these operations continuously until the power of the vehicle 9 is turned off.

### Effects of Embodiment

With the air conditioning control device 1 according to the present embodiment, operability can be improved. Specifically, the air conditioning control device 1 can set the temperature and airflow rate on the basis of coordinates at which an operation has been detected, thereby enabling the operability to be improved as compared to a case where the temperature and airflow rate are set separately.

In response to a touch operation in the first region 101 to the fourth region 104 made by the operator, the air conditioning control device 1 can determine and set a temperature and airflow rate combination predetermined for the region where the touch operation was made, thereby enabling the operator's desired setting to be made quickly as compared to the case where the temperature and airflow rate are set separately.

The air conditioning control device 1 can set the airflow rate along with the temperature in response to a tracing operation in the operation area 100 made by the operator, thereby enabling the setting to be made quickly and intuitively as compared to the case where the temperature and airflow rate are set separately. Additionally, the air conditioning control device 1 includes the display images 105, which the operator can easily associate with how high or low the temperature is, how high or low the airflow rate is, and the like, which makes it easy to operate the device more intuitively.

As a variation, the air conditioning control device 1 may be configured to allow setting values such as separate temperatures and airflow rates for the driver's seat and passenger's seat, and air outlet selections, and the temperature of a rear seat to be set, in addition to settings for the temperature and the airflow rate. Additionally, the air conditioning control device 1 may be configured so that setting values assigned to the first axis and the second axis are switched to setting values such as separate temperatures and airflow rates for the driver's seat and passenger's seat in response to a multi-touch operation, a switching operation, or the like made in the operation area 100.

Although several embodiments of the present invention and variations thereon have been described above, these embodiments and variations are merely examples, and the invention according to claims is not intended to be limited thereto. Such novel embodiments and variations can be implemented in various other forms, and various omissions, substitutions, changes, and the like can be made without departing from the spirit and scope of the present invention.

In addition, all combinations of the features described in these embodiments and variations are not necessary to solve the problem. Furthermore, these embodiments and variations are included within the spirit and scope of the invention and also within the invention described in the claims and the scope of equivalents thereof.

What is claimed is:

1. An air conditioning control device, comprising:
an operation detector that detects a touch operation made in an operation area by a detection target; and
a controller that sets, in the operation area, a two-dimensional coordinate system having a first axis related to a first setting value and a second axis related to a second setting value, and outputs a control signal to control an air conditioning device in accordance with the first setting value and the second setting value based on coordinates of the detection target in the two-dimensional coordinate system, the coordinates being detected by the operation detector.

2. The device according to claim 1, wherein the controller holds information on a first setting value and second setting value combination predetermined for each of a first quadrant to a fourth quadrant of the two-dimensional coordinate system, and controls the air conditioning device to deliver air adjusted on the basis of the predetermined first setting value and second setting value combination corresponding to a quadrant in which the touch operation has been made.

3. The device according to claim 2, wherein if a tracing operation made in the operation area is detected by the operation detector, the controller does not control the air conditioning device on the basis of the predetermined first setting value and second setting value combination, and controls the air conditioning device in accordance with the first setting value and the second setting value determined on the basis of coordinates of an end point of the tracing operation.

4. The device according to claim 1, wherein the predetermined first setting value is a temperature of air output from the air conditioning device, and
wherein the second setting value is an airflow rate of the air output from the air conditioning device.

5. The device according to claim 3, further comprising a display part,
wherein the controller controls the display part to display the predetermined first setting value second setting value combination or the first sefting value and the second setting value determined on the basis of the coordinates of the end point of the tracing operation.
